(19) United States
(12) Patent Application Publication
(10) Pub. No.: US 2020/0070573 A1
(43) Pub. Date: Mar. 5, 2020

(54) BICYCLE HUB SHAFT STRUCTURE

(71) Applicant: Yi-Tsang HSIEH, Taichung City (TW)

(72) Inventor: Yi-Tsang HSIEH, Taichung City (TW)

(21) Appl. No.: 16/120,421

(22) Filed: Sep. 3, 2018

(51) Int. Cl. B60B 35/04; B60B 27/02

(52) U.S. Cl. CPC B60B 35/04; B60B 27/023; B60B 2360/10; B60B 2900/212; B60B 2360/108; B60B 2310/318; B60B 2900/111; B60B 2360/104

(57) ABSTRACT

A bicycle hub shaft includes a first shaft section made of a first material and inserted into a sprocket seat; and a second shaft section made of a second material. The strength of the first material is stronger than that of the second material. The first shaft section has one end connected to one end of the second shaft section. The bicycle hub shaft is formed by the first and second shaft sections, instead of being integrally formed. Besides, the strength of the first shaft section is stronger than the second shaft section, so that the first shaft section inserted in the sprocket seat has a higher structural strength, thus improving the strength of the bicycle hub shaft and the load capacity of the sprocket seat as well.

### BACKGROUND

### Field of the Invention

The present invention relates to a hub shaft, and more particularly to a bicycle hub shaft structure.

### RELATED PRIOR ART

Generally, the bicycle hub shaft is inserted in a sprocket seat, and the outer edge of the sprocket seat is provided with a plurality of sprockets. The conventional bicycle hub shaft is made of lighter weight materials in order to maintain the advantage of lightweight. In addition, in order to meet the needs of the bicyclists, the range of bicycle speed change becomes more and more wide, and the number of bicycle shifting sections is also increased, so that the number of the sprockets mounted on the sprocket seat is also increased, which applies greater load on the bicycle hub shaft. In this case, the bicycle hub shaft often breaks due to the large load.

The present invention has arisen to mitigate and/or obviate the afore-described disadvantages.

### SUMMARY

One objective of the present invention is to provide a bicycle hub shaft structure capable of improving the strength of the bicycle hub shaft and the load capacity of the sprocket seat as well.

To achieve the above objective, a bicycle hub shaft structure in accordance with the present invention comprises:

a first shaft section made of a first material and used to insert into a sprocket seat, wherein the first shaft section is a hollow cylinder and has a first end, an opposite second end, and a first through hole running through the first end and the second end; and

a second shaft section made of a second material, wherein a strength of the first material is stronger than that of the second material, the second shaft section is a hollow cylinder and includes: a third end, an opposite fourth end, and a second through hole running through the third and fourth ends, the second end of the first shaft section is connected to the third end of the second shaft section, so that the first and second through holes are in communication with each other.

It can be learned from the above that the bicycle hub shaft of the invention is formed by the first and second shaft sections, instead of being integrally formed. Besides, the strength of the first shaft section is stronger than the second shaft section, so that the first shaft section inserted in the sprocket seat has a higher structural strength, thus improving the strength of the bicycle hub shaft and the load capacity of the sprocket seat as well.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a perspective view of a bicycle hub shaft structure in accordance with the present invention;

FIG. 2 is an exploded view of the bicycle hub shaft structure in accordance with the present invention;

FIG. 3 is a cross sectional view of the bicycle hub shaft structure in accordance with the present invention; and

FIG. 4 is another exploded view of the bicycle hub shaft structure in accordance with the present invention.

### DETAILED DESCRIPTION

The present invention will be clearer from the following description when viewed together with the accompanying drawings, which show, for purpose of illustrations only, the preferred embodiment in accordance with the present invention.

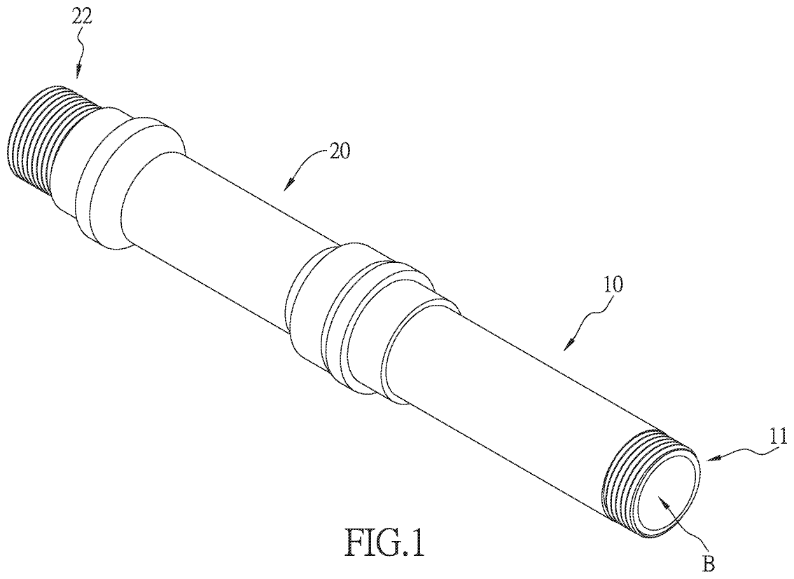

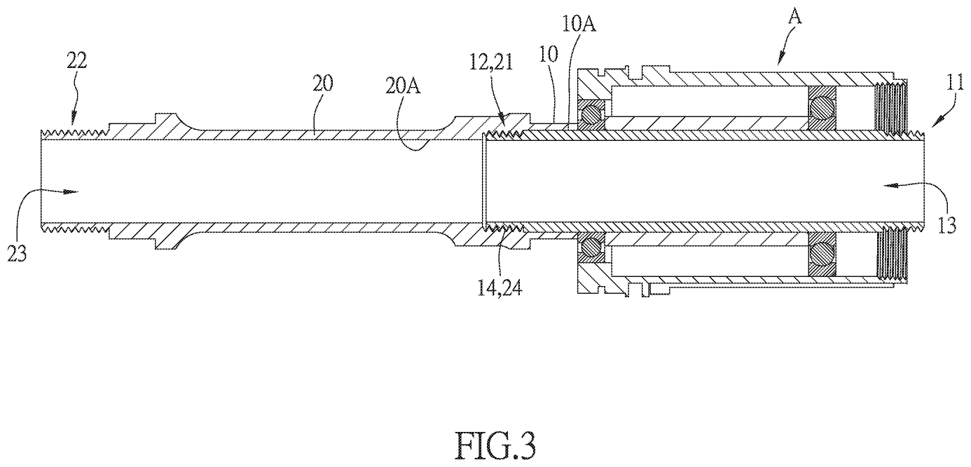

Referring to FIGS. 1-3, a bicycle hub shaft structure in accordance with the present invention is to be inserted in a sprocket seat, and comprises: a first shaft section 10 and a second shaft section 20.

The first shaft section 10 is made of a first material and inserted into the sprocket seat A. The first shaft section 10 is a hollow cylinder and has a first end 11, an opposite second end 12, and a first through hole 13 running through the first end 11 and the second end 12.

The second shaft section 20 is made of a second material. The strength of the first material is stronger than that of the second material, so that the weight of the second shaft section 20 is lighter than that of the first shaft section 10. The second shaft section 20 is a hollow cylinder and includes: a third end 21, an opposite fourth end 22, and a second through hole 23 running through the third and fourth ends 21, 22. The second end 12 of the first shaft section 10 is connected to the third end 21 of the second shaft section 20, so that the first and second through holes 13, 23 are in communication with each other. The bicycle hub shaft is not integrally formed.

In this embodiment, the first material may be an iron alloy or the like, and the second material is selected from the group consisting of aluminum alloys and titanium alloys.

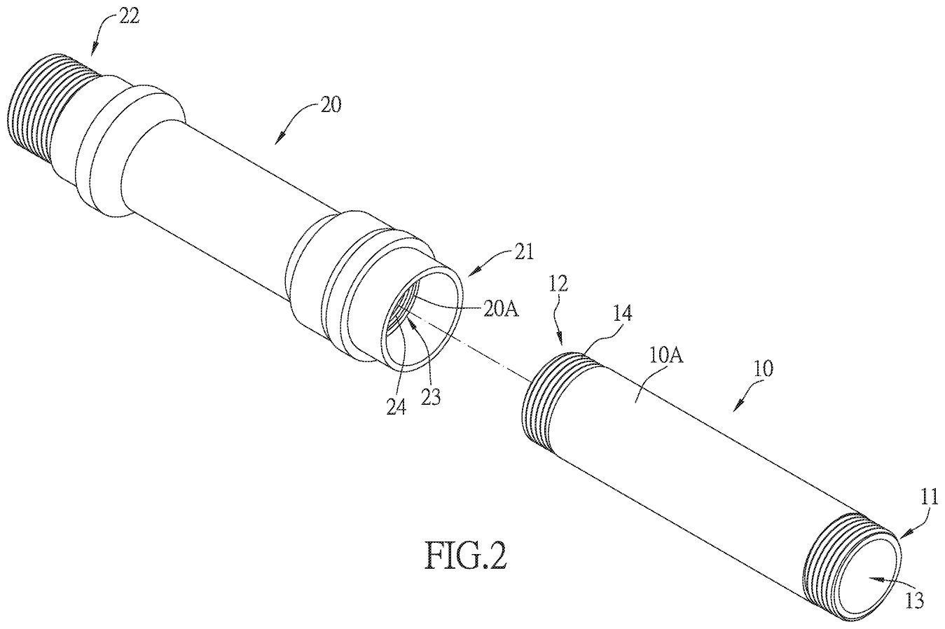

In the present embodiment, as shown in FIG. 2, an outer surface 10A of the first shaft section 10 at the second end 12 is provided with a first threaded portion 14. An inner surface 20A of the second shaft section 20 at the third end 21 of the second shaft section 20 is provided with a second threaded portion 24. The second end 12 of the first shaft section 10 is inserted in the third end 21 of the second shaft section 20, and the first threaded portion 14 is meshed with the second threaded portion 24, so that the first and second shaft sections 10, 20 are combined with each other.

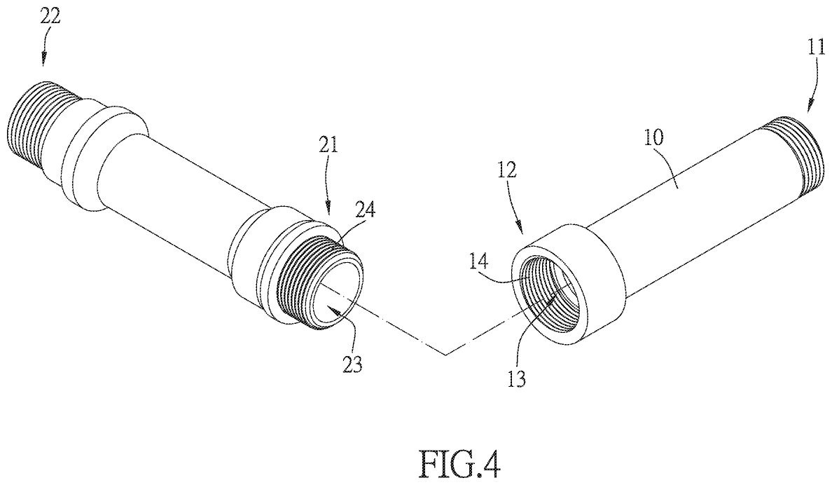

In another embodiment as shown in FIG. 4, the first threaded portion 14 is formed on an inner surface of the first shaft section 10 and located at the second end 12. The second threaded portion 24 is formed on an outer surface of the second shaft section 20 and located at the third end 21. The third end 21 of the second shaft section 20 is inserted in the second end 12 of the first shaft section 10, and the first threaded portion 14 is meshed with the second threaded portion 24, so that the first and second shaft sections 10, 20 are combined with each other.

In a preferred embodiment, an additional adhesive is provided between the first threaded portion 14 and the second threaded portion 24 to allow the first threaded portion 14 and the second threaded portion 24 to be meshed more tightly.

It can be learned from the above that the bicycle hub shaft of the invention is formed by the first and second shaft sections 10, 20 instead of being integrally formed. Besides, the strength of the first shaft section 10 is stronger than the second shaft section 20, so that the first shaft section 10 inserted in the sprocket seat A has a higher structural strength, thus improving the strength of the bicycle hub shaft and the load capacity of the sprocket seat A as well.

Besides, the first and second shaft sections 10, 20 are coupled to each other by threads engagement, so that the centers of the first and second shaft sections 10, 20 will not be misaligned, and the bicycle hub structure of the invention can maintain precision without swaying.

In addition, the outer surface of the bicycle hub shaft has a concave-convex shape, so the bicycle hub shaft of the present invention is formed by a first shaft section 10 and a second shaft section 20, and is easier to manufacture as compared with the integrally formed bicycle hub shaft, and therefore the manufacture cost can be reduced.

While we have shown and described various embodiments in accordance with the present invention, it is clear to those skilled in the art that further embodiments may be made without departing from the scope of the present invention.

What is claimed is:

1. A bicycle hub shaft structure, comprising:
a first shaft section made of a first material and used to insert into a sprocket seat, wherein the first shaft section is a hollow cylinder and has a first end, an opposite second end, and a first through hole running through the first end and the second end; and
a second shaft section made of a second material, wherein a strength of the first material is stronger than that of the second material, the second shaft section is a hollow cylinder and includes: a third end, an opposite fourth end, and a second through hole running through the third and fourth ends, the second end of the first shaft section is connected to the third end of the second shaft section, so that the first and second through holes are in communication with each other.

2. The bicycle hub shaft structure as claimed in claim 1, wherein the first material is iron alloy, and the second material is selected from the group consisting of aluminum alloy and titanium alloy.

3. The bicycle hub shaft structure as claimed in claim 1, wherein an outer surface of the first shaft section at the second end of the first shaft section is provided with a first threaded portion, an inner surface of the second shaft section at the third end of the second shaft section is provided with a second threaded portion, the second end of the first shaft section is inserted in the third end of the second shaft section, and the first threaded portion is meshed with the second threaded portion.

4. The bicycle hub shaft structure as claimed in claim 1, wherein the first shaft section includes a first threaded portion, the second shaft section includes a second threaded portion, the first threaded portion is formed on an inner surface of the first shaft section and located at the second end, the second threaded portion is formed on an outer surface of the second shaft section and located at the third end, the third end of the second shaft section is inserted in the second end of the first shaft section, and the first threaded portion is meshed with the second threaded portion.

5. The bicycle hub shaft structure as claimed in claim 3, wherein an adhesive is provided between the first threaded portion and the second threaded portion.

6. The bicycle hub shaft structure as claimed in claim 4, wherein an adhesive is provided between the first threaded portion and the second threaded portion.
